(19) United States
(12) Patent Application Publication
(10) Pub. No.: US 2007/0245572 A1
(43) Pub. Date: Oct. 25, 2007

(54) Knives

(76) Inventor: William Alfred Ireland, Churchdown (GB)

Correspondence Address: JOEL D. SKINNER, JR.;SKINNER AND ASSOCIATES, 212 COMMERCIAL ST., HUDSON, WI, 54016, US

(21) Appl. No.: 11/786,917

(22) Filed: Apr. 14, 2007

(30) Foreign Application Priority Data
Apr. 22, 2006 (GB) 0608004.8

(51) Int. Cl. B26B 29/00

(52) U.S. Cl. 30/294; 30/2

(57) ABSTRACT

A knife comprising a handle 100, a blade mounted on the handle 100 so that a portion of the blade, formed with a cutting edge, projects from the handle 100, a blade guard 104 which extends adjacent at least part of the cutting edge in spaced relation thereto, and a support 108 which connects the guard 104 to the handle 100, which support is shaped such that, in use, it does not cause the cut material to be forced apart in the plane of the cut material.

The invention relates to knives and particularly to safety knives of the kind where the portion of the knife blade which projects from the handle has an associated blade guard which extends adjacent at least a part of the cutting edge of the blade in spaced relation thereto. One end of the guard is spaced from the knife handle so as to provide a gap so that the blade can only cut a material or object which is thin enough to pass through that gap to reach the blade.

Safety knives of this kind are commonly used, for example, for cutting cardboard, the knife being drawn over the edge of a sheet of cardboard so that the sheet enters the gap between the handle and the blade guard so as to engage the cutting edge of the blade, which is usually inclined to the guard so that the cardboard passes into the acute angle between the blade and guard. Such knives are frequently used by staff in stores to open large cardboard boxes in which goods for retail are stored and conveyed in bulk. It is therefore important that the knife should be effective, quick and simple to operate, and should involve no risk of injury to the user. However, existing knives of this type suffer from certain disadvantages.

For example, in order that the cutting edge of the blade may engage the cardboard, the means connecting the blade guard to the handle must be disposed rearwardly of the cutting edge, with respect to its direction of cutting, so that the connecting means can pass along the cut opened up by the blade. In existing knives the connecting means is substantially thicker than the blade and tends to force the sides of the cut apart as it follows the blade along the cut. This not only creates frictional resistance to the passage of the knife through the material but may also tend to tear the material where it meets the blade so that the cut is somewhat ragged. Also, the engagement of the connecting means with the sides of the cut tends to oppose any attempt to steer the blade in a particular direction, such as along a curve, as it cuts through the cardboard.

Additionally, the cardboard is cut as a result of being wedged into the acute angle between the cutting edge of the blade and the blade guard. This wedging action provides substantial resistance to the passage of the blade through the material, particularly if the blade is becoming blunt, and also tends to cause some tearing, rather than clean cutting, of the material. These problems particularly arise in the case where the cardboard is relatively thick corrugated cardboard.

The present invention sets out to provide a safety knife of improved design to overcome or alleviate some or all of these problems.

According to a first aspect of the invention there is provided a knife comprising a handle, a blade mounted on the handle so that a portion of the blade, formed with a cutting edge, projects from the handle, a blade guard which extends adjacent at least a part of the cutting edge in spaced relation thereto, and a support which connects the guard to the handle, which support is shaped such that, in use, it does not cause the cut material to be forced apart in the plane of the cut material.

The support may comprise a thin plate-like element.

The support is preferably generally co-planar with the blade and is conveniently capable of limited angular movement relative to the plane of the blade.

Since the support is capable of limited angular movement relative to the blade it can yield slightly in response to lateral pressure from the material on either side of the cut thereby reducing resistance to passage of the blade and support through the material, and may for example readily allow the blade to be steered in a particular direction through the material. Furthermore, resistance to movement of the support through the cut is also reduced due to the support being a thin plate-like element which is substantially co-planar with the blade.

Preferably the plate-like support element is resiliently flexible, the limited angular movement then being provided by flexing of the support itself. However, the invention does not exclude arrangements where the support element is substantially rigid but is connected to the knife handle by means which allow movement of the support element relative to the blade, or arrangements in which no such movement is permitted.

The plate-like support element may be substantially wholly disposed to one side of the blade. For example, the element may have an edge which lies alongside an edge of the blade so that the support effectively forms a co-planar extension of the blade.

The plate-like support element may be of comparable thickness to the thickness of the blade. It is preferably slightly thinner than the blade, but can also be of substantially the same thickness as the blade, or slightly thicker. The support element may be formed from metal, plastics or any other material of sufficient strength to carry the blade guard.

In any of the above arrangements at least a portion of the blade guard may define a longitudinal channel into which at least part of the cutting edge of the blade extends. Preferably the cutting edge of the blade extends partly into the channel at a shallow acute angle.

The channel may be generally U-shaped in cross-section, and the width of the channel on each side of the blade is preferably substantially greater than the thickness of the blade. It is found that such an arrangement enhances the cutting effect of the blade on the material since, as cutting takes place, the portion of the material being cut is deflected downwardly beneath the blade and into the channel shape, this increasing the pressure of the surface of the material against the cutting edge and thus enhancing the cutting action.

Either end of the blade guard, or both ends, may be tapered and may project from the handle so that the guard may be used initially to pierce a material which is to be subsequently cut by the blade.

Preferably the blade guard is integral with its plate-like support element. For example, the support and guard may be bent from a single piece of metal.

In a particular embodiment according to the invention the blade guard is spaced from a surface of the handle, the plate-like support element and the projecting portion of the blade extending across the gap between the blade guard and said surface. Preferably the gap increases in width as it extends away from the end thereof towards which the cutting edge of the blade faces. Preferably the end of the gap towards which the cutting edge of the blade faces has a width which is not greater than about 5mm. Thus, an object (such as the fingers of the user) or material which has dimensions greater than this cannot be introduced through the gap for engagement with the blade.

According to a second aspect of the invention there is provided a knife comprising a handle, a blade mounted on the handle so that a portion of the blade, formed with a cutting edge, projects from the handle, a blade guard which extends along at least a part of the cutting edge and in spaced relation thereto, and a support which connects the guard to the handle, at least a portion of the blade guard defining a longitudinal channel into which at least part of the cutting edge of the blade projects.

The knife according to this aspect of the invention may also have any of the other features referred to above.

In any of the arrangements described hereinbefore, the blade may be moveable relative to the guard. Conveniently, the blade is slidably mounted relative to the guard.

In any of the arrangements described hereinbefore, rather than provide a support of plate like form, the support may be of relatively great thickness, but include channels through which the cut edges of the material can pass, the channels on opposing sides of the support conveniently being out of alignment with one another so as to deflect one of the cut edges downwards relative to the other of the cut edges.

The invention will further be described, by way of example, with reference to the accompanying drawings in which:

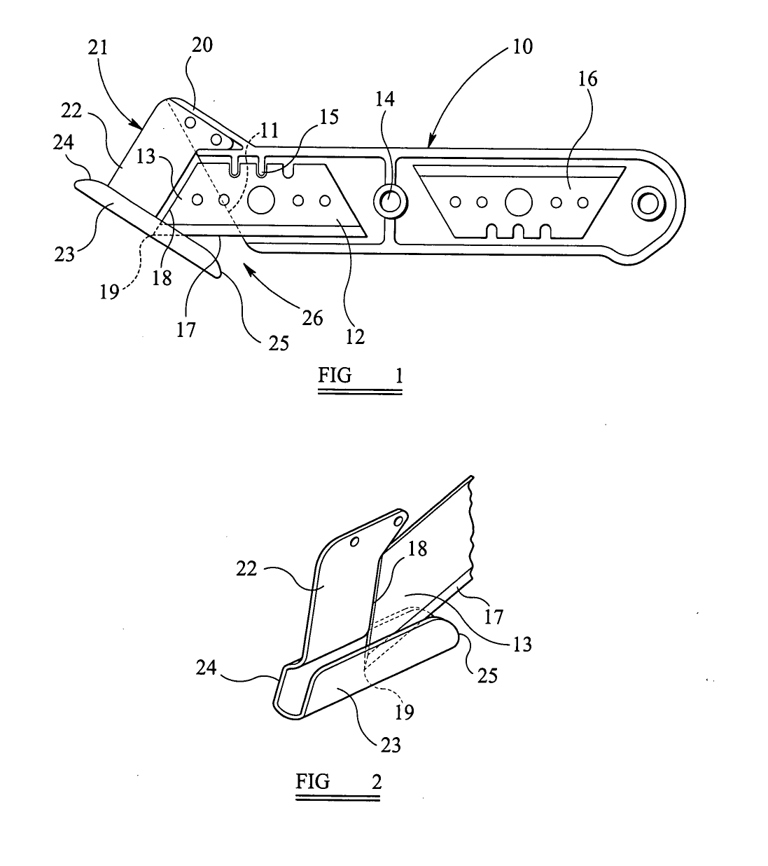

FIG. 1 is a diagrammatic longitudinal section through one form of knife in accordance with the invention,

FIG. 2 is a diagrammatic perspective view of the projecting portion of the blade and its associated blade guard and support element,

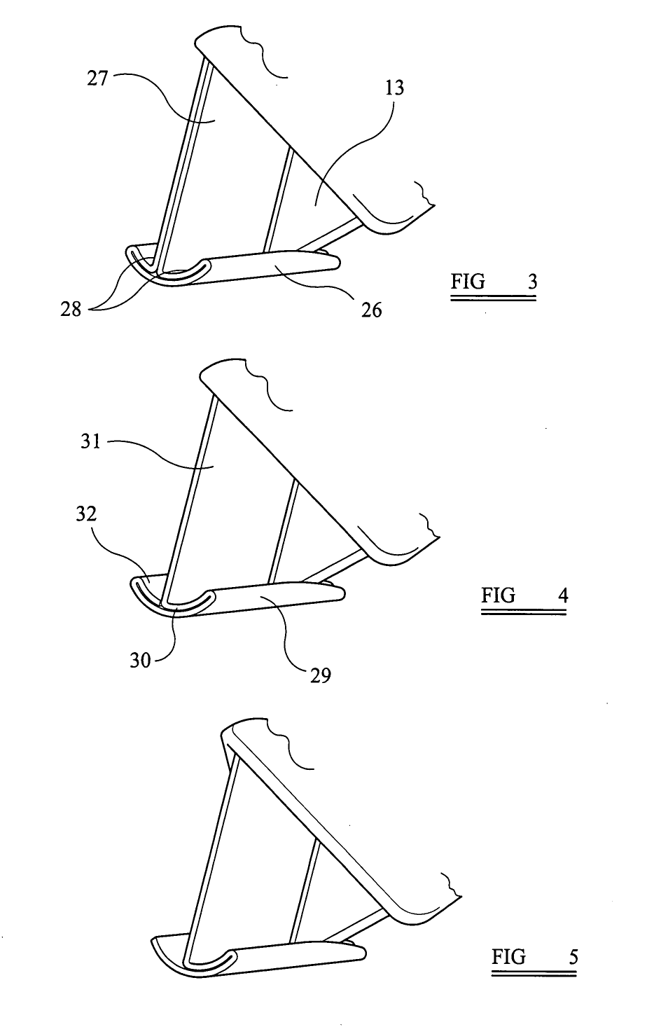

FIGS. 3 to 5 are similar views to FIG. 2 of alternative forms of construction of the blade guard,

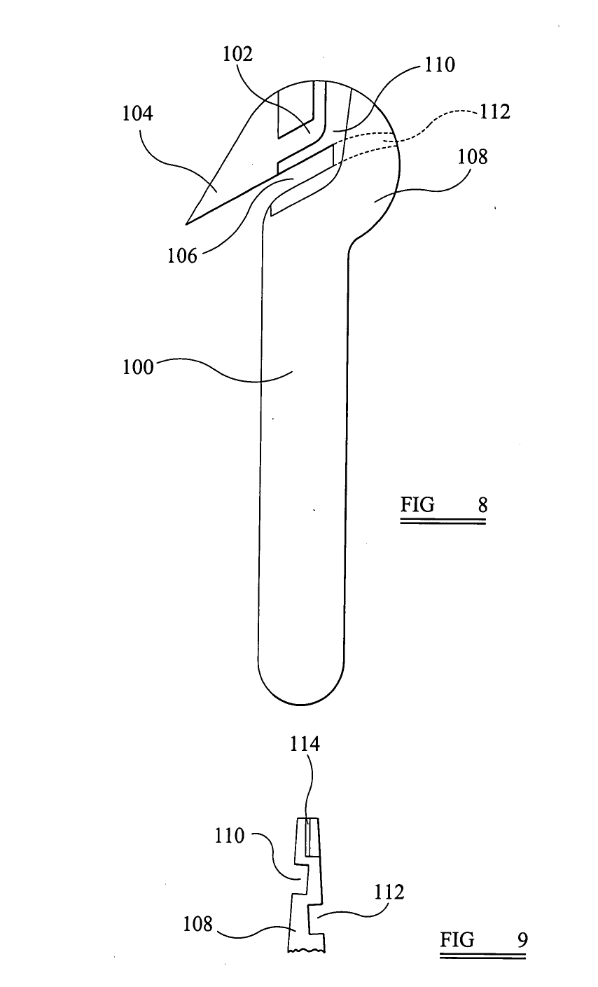

FIGS. 6 and 7 are views illustrating an alternative knife,

FIG. 8 is a view of a component of a further alternative design, and

FIG. 9 is an end view of part of the component shown in FIG. 8.

Referring to FIG. 1, the knife comprises a handle 10 having an inclined end surface 11 and a fixed blade 12 mounted within the handle and having a triangular portion 13 projecting beyond the end surface 11 of the handle.

The handle is formed in two hollow parts which are clamped together in known manner by a screw passing through a central hole 14 which is threaded on one of the handle halves. The blade 12 is clamped between the two halves, the projecting portion 13 of the blade passing through a narrow slot in the inclined end surface 11. In known manner the blade 12 is located by means of projections 15 on the inner surface of the handle which engage corresponding notches in the back edge of the blade. Spare blades, as indicated at 16, maybe stored in another part of the hollow handle.

The projecting portion 13 of the blade has a cutting edge 17 and an end edge 18 meeting at a point 19.

The two halves of the handle 10 are each formed with an upwardly inclined extension 20 adjacent the end surface 11 and mounted between the extensions 20 is the upper end of a blade guard assembly 21.

The blade guard assembly 21 comprises a support element 22 and a blade guard 23. The upper end of the support element 22 may be riveted to one of the extensions 20 or may be simply clamped between the two halves of the blade handle, being located on short posts on one half which engage in holes in the element.

The support element 22, which is shown in greater detail in FIG. 2, comprises a thin plate having parallel side edges, one side edge lying closely alongside the end edge 18 of the projecting portion 13 of the blade, so that the plate 22 is co-planar with the blade 12.

The blade guard 23 is carried on the lower end of the support element 22 and is preferably integrally formed with it. For example, the support element and blade guard may be pressed from a single piece of thin metal sheet or may be integrally moulded from a suitably strong and resilient plastics material.

The blade guard 23 is generally U-shaped in cross-section, as best seen in FIG. 2, and extends at a shallow angle to the cutting edge 17 of the blade so that the pointed end 19 of the blade projects generally centrally into the channel section. The width of the channel section is such as to provide on each side of the blade portion 13 a gap which is substantially greater in thickness than the thickness of the blade itself. The opposite ends of the blade guard 23 are tapered, as indicated 24 and 25. The tapered end 25 which is adjacent the cutting edge 17 of the blade is spaced from the adjacent portion of the inclined end surface 11 by a gap 26 which is preferably no more than about 5 mm wide. Due to the angles of inclination of the end surface 11 and the blade guard 23, the spacing between them increases with distance away from the narrow gap 26.

The thickness of the support element 22 is comparable to the thickness of the blade 12 although in practice it may be somewhat thinner or thicker. Preferably it is slightly thinner than the blade. The element is substantially co-planar with the projecting portion 13 of the blade. The material from which the support element 22 is formed is such that it is capable of slight angular resilient flexing relative to the blade.

In order to cut a material, such as a sheet of corrugated cardboard, the gap 26 between the blade guard 23 and the handle 10 is placed over an edge of the cardboard and the knife is then drawn towards the user so that the cutting edge 17 cuts through the cardboard. The cardboard is constrained between the blade guard 23 and the handle so that the cutting edge 17 cannot slip out of the cut. The support element 22 follows the projecting portion 13 of the blade along the cut, and since it is of similar thickness to the blade it does not significantly bear frictionally against the side of the cut and so does not hamper the passage of the blade through the material.

Due to its inherent flexibility, the support 22 can move slightly angularly relative to the blade and thus the direction of movement of the blade is not constrained by the support. The blade can therefore move through the cardboard in any direction the user desires, for example the cardboard may be cut in a fairly tight curve if required.

Since the cutting edge of the blade passes into a comparatively wide channel in the blade guard 23, the edge of the cardboard does not tend to become jammed between the blade and the guard but instead becomes slightly deflected into the channel as the user applies drawing pressure to the knife. This slight bending of the cardboard as it is forced into the channel increases the pressure of the cardboard against the cutting edge 17 and thus enhances the cutting action. The knife therefore effects a clean and swift cut through the cardboard without significant tearing or other deformation of the cardboard material on each side of the cut.

The flared angle between the blade guard 23 and the surface 11 on the handle enables the user to hold the knife in any of a wide range of angular positions relative to the cardboard. In practice the user will automatically hold the knife at the angle which provides the least resistance to the passage of the blade through the material.

Since the cutting edge 17 of the blade is only accessible through the narrow gap 26, the guard 23 prevents or minimises the possibility of injury through misuse of the knife, since the gap 26 is too small to allow a finger to engage the cutting edge of the knife.

The channel shape of the guard 23 also prevents sideways access of fingers on to the cutting edge 17 of the blade.

The tapered ends 24 and 25 of the blade guard 23 may be used to stab an initial hole in a sheet of cardboard, if it is wished to start a cut within the sheet rather than at the edge. However, although the ends of the blade guard are sufficiently tapered to permit this stabbing action, the edges of the guard along the tapered portion are smoothly curved and extend over a comparatively large area so that they will not cut anyone handling the knife.

In the case where the guard assembly 21 is formed from metal, the metal, which is preferably steel, is heat treated after forming to give the necessary springy quality to the assembly without making it brittle and the assembly may then be given a final treatment to protect it against corrosion.

The safety knife described above is particularly suitable for cutting cardboard and similar materials, and especially the thick corrugated cardboard used for boxes of retail goods delivered to supermarkets. The knife is safe to use for cutting open such boxes with minimal risk of accidental injury to anyone handling the knife, no matter how it is used.

If the knife is to be used for cutting particularly thin material, it may be desirable to provide an insert in the blade guard 23 so as to reduce the internal size of the channel section and provide a convergent duct so as to guide the thinner material into firm contact with the blade without undue bending of the material. The insert may be formed from any suitable material, but a low-friction plastics, such as PTFE, is preferred.

FIGS. 3 to 5 show diagrammatically various alternative forms of construction for the blade guard. In each case the blade guard is bent from a single suitably-shaped sheet metal blank.

In the arrangement of FIG. 3 the metal blank which is bent to form the curved blade guard 26 has extending from each side thereof two symmetrical parallel-sided wings of metal which are folded inwardly across part of the upper side of the blade guard 26, as indicated at 28, and then upwardly alongside one another to form a double thickness support 27.

In the modified arrangement of FIG. 4 the central portion of the metal blank which is bent to form the blade guard 29 has at one side only a single long parallel-sided wing which is bent inwardly over the blade guard 29 as indicated at 30 and then upwardly so as to provide a support 31 comprising a single thickness of the metal sheet. The other edge of the blade guard 29 is formed with a much shorter wing which is folded inwardly as indicated at 32 so as to overlie half of the curved blade guard 29 and to abut the lower end of the support 31.

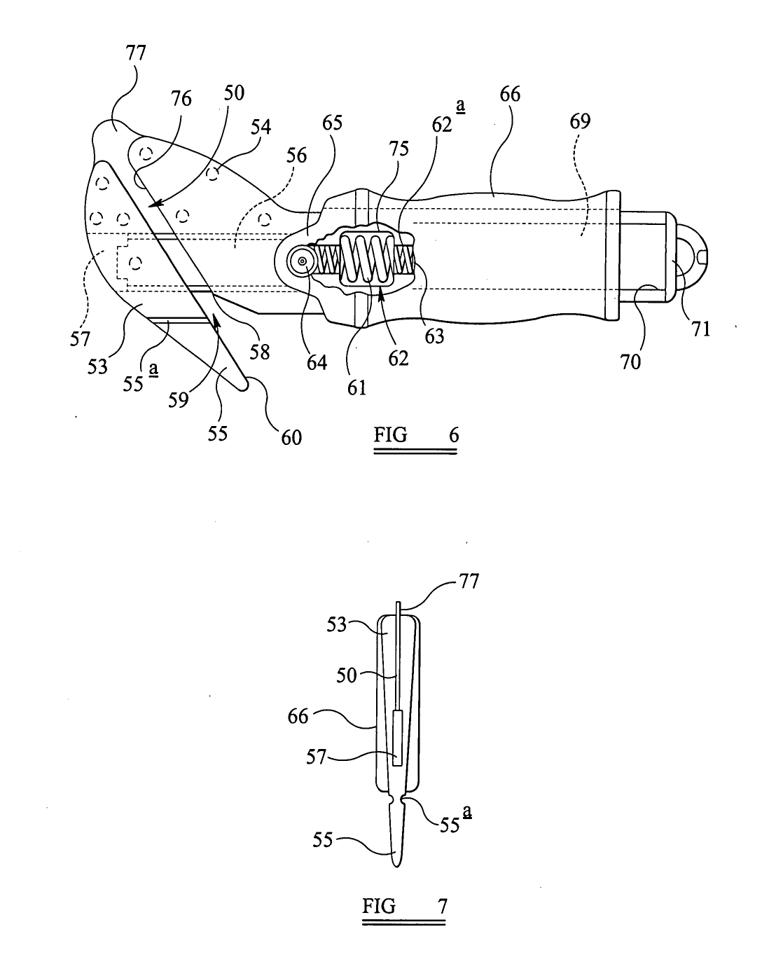

The arrangement of FIG. 5 is similar to that of FIG. 4 except that the short folded-in wing of metal 32 is omitted.

FIGS. 6 and 7 show an alternative form of safety knife in accordance with the invention. The main body of the knife comprises a thin metallic support member 50 carrying a head part 53 and a handle part 54, both of which comprise plastics mouldings secured onto one or both sides of the member 50. A tapered tip portion 55 of the head part 53 is inclined backwardly towards the handle part 54. A blade 56 is slidable in a slot 57 extending within the head part 53 and the handle part 54 and has an exposed portion 58 of its cutting edge extending across a slot 59 defined between the head and handle parts 53, 54. The cutting edge 58 extends at an acute angle to the inner surface 60 of the tip portion 55.

The blade 56 is urged to the left by a helical compression spring 61 which is located within a cylindrical cavity 62 forming an extension of the slot 57. One end of the compression spring 61 abuts the end 63 of the cavity 62 and the opposite end abuts a transverse plastics material or metallic pin 64 which extends through a hole in the blade 56.

Opposite ends of the pin 64, outside the handle 54, pass through holes in parallel lugs 65 formed at one end of an elongate sleeve 66 which is slidable on the handle portion 54. The pin 64 is formed with an enlarged knurled head by which the pin may be manipulated. The opposite end of the pin 64 is also slightly enlarged in diameter. The size of the aperture in the lug 65 adjacent the head of the pin is such that considerable pressure is required to force the enlarged end of the pin through it, whereas the enlarged end enters the aperture in the opposite lug more easily, although it is still frictionally restrained thereby. This arrangement means that when the pin 64 is withdrawn to change the blade 56, the enlarged end of the pin cannot easily slip through the aperture in the lug 65 adjacent the head, so that the pin is retained on the sleeve 66 and will not be lost.

In addition to the frictional engagement between the end of the pin 64 and the lug 65, the force exerted on the pin 64 by the compression spring 61 also serves to retain the pin in position.

The opposite internal surfaces of the sleeve 66 are formed with longitudinal projections 69 which engage in, and are slidable along, shallow recesses 70 formed in the lateral surfaces of the handle portion 54. Movement of the sleeve 66 to the left in FIG. 6 is limited by engagement of the pin 64 with the end of the cavity 62 and by the engagement of the lugs 65 with correspondingly shaped end surfaces of the shallow recesses 70. Movement of the sleeve 66 to the right in FIG. 6 is limited by engagement of the end of the sleeve with an upstanding ridge 71 on one side of the end of the handle portion 54.

In use, the user grips the knife by the sleeve 66, introduces the tapered tip portion 55 beneath the material to be cut and draws the knife towards himself. The pulling action causes the sleeve 66 to slide along the handle portion 54, to the right in FIG. 6, thus causing the blade 56 to slide across the slot 59 and thereby enhance the cutting action. The parts 53, 54 are spaced apart from one another so as to define therebetween narrow grooves 76 which form a continuation of the slot 59 so that the cut edges of the material being cut pass along the grooves 76. The depths of the grooves 76 are limited only by the presence of the support member 50 and the blade such that there is minimal resistance to the movement of the blade through the material being cut, as shown in FIG. 7.

When it is wished to replace the blade 56, the pin 64 is withdrawn and the sleeve 66 moved to the right, as viewed in FIG. 6, to expose the end of the blade. An implement may then be engaged in the hole in the end of the blade to move the blade to the left so that its opposite end projects through the opening at the end of the slot 57 so that the blade may be withdrawn and replaced by a new one. However, in some cases it may not be required that the blade should be replaceable, for example for safety reasons, and in that case the pin 64 may be permanently retained in position. For example, the end of the pin opposite the head 67 may project beyond the surface of the lug 65 and may then be deformed so that the pin cannot be withdrawn.

The support member 50 may further define a projection serving, in use, as a tape cutter 77.

A knife of this type may be subject to abuse leading to damage to the portion 55, for example resulting in the portion 55 snapping off. It will be appreciated that this could result in the blade being exposed, and that there is then a risk of injury to an operator or user of the knife. In order to reduce the risk of such injury, the knife is conveniently designed to include a line of weakness 55a such that should the knife be subject to abuse, the portion 55 is most likely to break away from the remainder of the knife at the line of weakness 55a. The line of weakness is positioned such that, should the portion 55 be broken away, access to the blade is still restricted.

FIG. 8 illustrates a preferred embodiment which is similar to that described with reference to FIGS. 6 and 7, but in which the head part and handle part are formed integrally with one another. They could be formed by a plastics moulding, or alternatively could be of metallic form.

As shown in FIGS. 8 and 9, the knife comprises a handle 100 including an integral head portion 102. The head portion 102 is shaped to define a nose 104. A blade is located within a passage 114 formed in the handle 100, the blade extending across a channel 106 defined between the main part of the handle 100 and the head portion 102.

The handle defines a support region 108 integrally connecting the main portion of the handle 100 and the head portion 102, the support region 108 being shaped to define flow channels 110, 112 which form continuations of the channel 106. As can be seen in FIG. 9, the flow channels 110, 112 are out of alignment with one another with the result that, in use, the cut edges of the material cut by the blade passes through the flow channels 110, 112 and one of the cut edges is deflected downwards relative to the other, in the orientation illustrated. By positioning the flow channels 110, 112 out of alignment with one another, the various parts of the support region 108 can be designed to be of relatively great thickness, and hence of good strength, thereby enabling the support region 108 to take the form of, for example, a plastics moulding. The depths of the flow channels 110, 112 are chosen such that the bases of the channels 110, 112 lie substantially in the plane of, or beneath the plane of, the corresponding side surfaces of the blade. If desired, the channels may be of tapering depth, the depth increasing with increasing distance from the blade, so as to further reduce resistance whilst maintaining strength.

The remainder of the knife is very similar to that shown in FIG. 7 and so will not be described in further detail. In the use, the knife operates in a manner very similar to that of FIG. 7, the blade being moveable relative to the handle and head portion. A spring biasing arrangement is provided between the handle 110 and associated sleeve and, if desired, the spring biasing may incorporate two springs, for example with one located within the other, only one of which operates during initial movement, the other of which comes into play after movement of the handle beyond a predetermined position. As a result, a two rate spring biasing arrangement may be provided which may be desirable in some circumstances.

It will be understood that the arrangements described above are by way of example only, and the invention is not limited to the particular described constructions of the handle or of the blade guard assembly. For example, the sleeve could be of two-art construction, the pin being formed integrally with the sleeve, the two parts of the sleeve being designed to snap or otherwise connect to one another during assembly. A further possibility is to provide a tape cutter in a channel provided on the support region, the blade being movable to an extended position in which it can be used, for example, to puncture or cut tape.

1. A knife comprising a handle, a blade mounted on the handle so that a portion of the blade, formed with a cutting edge, projects from the handle, a blade guard which extends adjacent at least a part of the cutting edge in spaced relation thereto, and a support which connects the guard to the handle, which support is shaped such that in use, it does not cause the cut material to be forced apart in the plane of the cut material.

2. A knife according to claim 1, wherein the support comprises a thin plate-like element.

3. A knife according to claim 2, wherein the support is generally co-planar with the blade.

4. A knife according to claim 3, wherein the support is capable of limited angular movement relative to the plane of the blade.

5. A knife according to claim 4, wherein the plate-like support element is resiliently flexible, the limited angular movement then being provided by flexing of the support itself.

6. A knife according to claim 2, wherein the plate-like support element is substantially wholly disposed to one side of the blade.

7. A knife according to claim 2, wherein the plate-like support element is of comparable thickness to the thickness of the blade.

8. A knife according to claim 1, wherein at least a portion of the blade guard may define a longitudinal channel into which at least part of the cutting edge of the blade extends.

9. A knife according to claim 1, wherein the cutting edge of the blade extends partly into the channel at a shallow acute angle.

10. A knife according to claim 1, wherein the blade guard is integral with its plate-like support element.

11. A knife according to claim 1, wherein the blade is movable relative to the guard.

12. A knife according to claim 11, wherein the blade is slidably mounted relative to the guard.

13. A knife according to claim 1, wherein the support is of relatively great thickness and include channels through which the cut edges of the material can pass.

14. A knife according to claim 13, wherein the channels on opposing sides of the support are out of alignment with one another so as to deflect one of the cut edges downward relative to the other of the cut edges, thereby avoiding deflection of the cut edges away from one another in the plane of the material.
